(19) United States
(12) Patent Application Publication
(10) Pub. No.: US 2016/0378415 A1
(43) Pub. Date: Dec. 29, 2016

(54) PRINTER, BARCODE PRINTER AND PRINTER CONTROL METHOD

(71) Applicant: TOSHIBA TEC KABUSHIKI KAISHA, Tokyo (JP)

(72) Inventor: Fusao Hori, Izu (JP)

(21) Appl. No.: 15/262,190

(22) Filed: Sep. 12, 2016

Related U.S. Application Data
(63) Continuation of application No. 14/662,418, filed on Mar. 19, 2015.

(51) Int. Cl. G06F 3/12; G06K 15/02; G06K 19/06; G06K 15/00

(52) U.S. Cl. CPC G06F 3/1259; G06F 3/121; G06F 3/1253; G06K 15/005; G06K 15/021; G06K 19/06028

(57) ABSTRACT

In accordance with one embodiment, a printer comprises a plurality of communication interfaces; an operation interface setting section configured to set at least one of the plurality of communication interfaces as an operation interface and set the other communication interfaces as non-operation interfaces; a first command processing section configured to process a command received by the operation interface; and a second command processing section configured to execute the processing of the command in a case in which the command received by the non-operation interface is a command for requesting internal information of the printer, and not to execute the processing of the command in a case in which the command received by the non-operation interface is not a command for requesting the internal information.

### CROSS-REFERENCE TO RELATED APPLICATIONS

This application is a Continuation of application Ser. No. 14/662,418 filed on Mar. 19, 2015, the entire contents of which are incorporated herein by reference.

### FIELD

Embodiments described herein relate generally to a printer, a barcode printer and a printer control method.

### BACKGROUND

There is a printer (such as a barcode printer used in a manufacturing line) which is under the control of a host device for a long period. Such a printer activates a communication interface connected with the host device merely and deactivates all other communication interfaces during operation. In this way, the printer prevents a command input from other device than the host device.

For example, in a case in which the printer executes an unexpected operation, a user may desire to confirm internal information of the printer during the operation of the printer. However, in the printer mentioned above, the host device occupies all the active communication interfaces during the operation of the printer, thus, the user cannot confirm the internal information of the printer.

The user who desires to confirm the internal information has to interrupt the operation of the printer temporarily to release the communication interface from the host device. However, in a case in which the printer is used in the manufacturing line, the whole manufacturing line is stopped if the operation of the printer is stopped, which brings about great loss to the user.

It is considered to delay the confirmation of the internal information till the operation of the manufacturing line is stopped. However, in most cases, the operation of the manufacturing line is not stopped until the end of the day. Thus, in a case of waiting for the operation stop of the manufacturing line to confirm the internal information of the printer, the user or serviceman has to wait for a long time.

### BRIEF DESCRIPTION OF THE DRAWINGS

FIG. 1 is a diagram illustrating the constitution of a printing system including a printer according to one embodiment;

FIG. 2 is a block diagram illustrating the printer according to the embodiment;

FIG. 3 is a functional block diagram illustrating a control section of the printer according to the embodiment;

FIG. 4 is a flowchart illustrating an operation interface setting processing;

FIG. 5 is a flowchart illustrating a first command processing; and

FIG. 6 is a flowchart illustrating a second command processing.

### DETAILED DESCRIPTION

In accordance with one embodiment, a printer comprises a plurality of communication interfaces; an operation interface setting section configured to set at least one of the plurality of communication interfaces as an operation interface and set the other communication interfaces as non-operation interfaces; a first command processing section configured to process a command received by the operation interface; and a second command processing section configured to execute the processing of the command in a case in which the command received by the non-operation interface is a command for requesting internal information of the printer, and not to execute the processing of the command in a case in which the command received by the non-operation interface is not a command for requesting the internal information.

Hereinafter, the present embodiment is described with reference to the accompanying drawings. Further, the same components are indicated by the same reference numerals in the drawings.

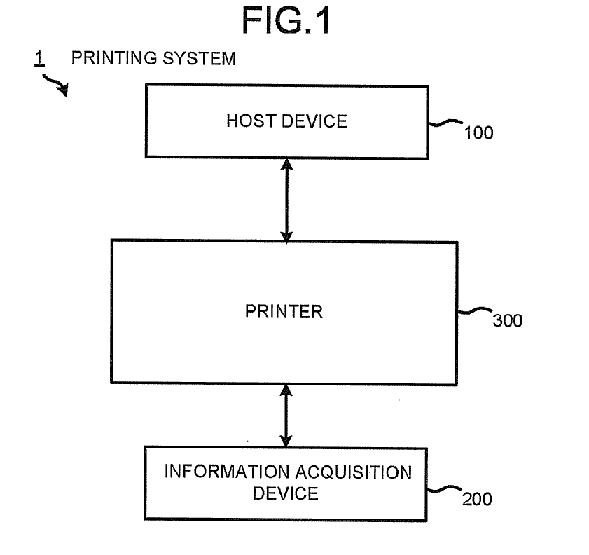

FIG. 1 is a diagram illustrating a printing system including the printer of the embodiment. A printing system 1 includes a host device 100, an information acquisition device 200 and a printer 300. The printing system 1 is used in, for example, the printing of package in manufacturing line.

The host device 100 controls various devices included in the manufacturing line. The host device 100 is, for example, a data processing device such as a personal computer, a server device and the like. The host device 100 and the printer 300 are connected with each other through a communication cable. The host device 100 sends a command to the printer 300 according to a control program of the manufacturing line executed at the inside.

The information acquisition device 200 acquires internal information of the printer 300 from the printer 300. The information acquisition device 200 is, for example, a data processing device such as a personal computer, a tablet terminal and the like. The information acquisition device 200 is connected with the printer 300 by a user. The information acquisition device 200 sends a command to the printer 300 according to an operation of the user.

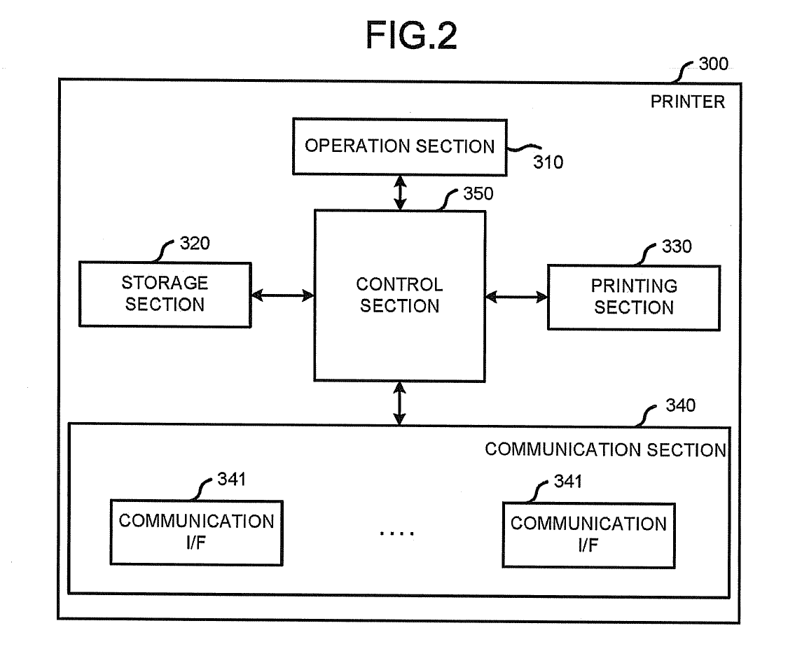

The printer 300 is arranged in the manufacturing line to be used for mass printing. The printer 300 is, for example, a barcode printer capable of printing one-dimensional code (barcode) or two-dimensional code (two-dimensional barcode). The one-dimensional code that the printer 300 can print may be a UPC (Universal Product Code) or a CODE39. The two-dimensional code that the printer 300 can print may be a DATA Matrix or a QR-code (quick response code). As shown in FIG. 2, the printer 300 is provided with an operation section 310, a storage section 320, a printing section 330 and a communication section 340.

The operation section 310 is a user interface such as buttons, switches, touch panel and the like. The operation section 310 notifies the control section 350 of an input from the user.

The storage section 320 is a storage device capable of reading and writing data such as a DRAM (Dynamic Random Access Memory), a SRAM (Static Random Access Memory), a flash memory, a hard disk drive and the like. The storage section 320 stores various kinds of information such as the internal information of the printer 300 and the like. The internal information includes, for example, an “internal setting value” used by the printer 300 in various processing, and “error information” accumulated by the printer 300 during the operation.

The “internal setting value” refers to setting values used by the printer 300 in various processing, such as a color/density correction value, a fine adjustment value of printing position, and various wait time and the like. The internal setting value includes not only the value set by the user but also the value set by the printer 300 itself through adjustment.

The “error information” refers to, for example, the information accumulated during the operation of the printer 300 for analyzing an error occurring in the printer 300, such as error code output by the print control program of the printer 300 during the printing processing execution.

The internal information is not limited to the internal setting value and the error information. For example, various kinds of information accumulated inside the printer 300 such as the number of execution times of printing in one day may also be regarded as the internal information.

The printing section 330 carries out printing on a printing medium such as a product package, a label seal and the like. The printing section 330 may be, for example, a dot impact type or a thermal type printer that carries out printing on the recording medium. The printing section 330 carries out printing on the printing medium under the control of the control section 350.

The communication section 340 communicates with an external device. The communication section 340 includes a plurality of communication interfaces 341. The plurality of communication interfaces 341 is of different communication standards to cope with various communication standards. In the present embodiment, the plurality of communication interfaces 341 consists of four communication interfaces, that is, a LAN (Local Area Network) interface, a USB (Universal Serial Bus) interface, an RS-232C standard serial interface and a centronics (IEEE1824) standard parallel interface. In the following description, the RS-232C standard serial interface is referred to as an RS-232C interface. The centronics (IEEE1824) standard parallel interface is referred to as a centronics parallel interface.

The control section 350, which is a processing device such as a processor and the like, functions as a control device of the printer 300. The control section 350 operates according to the programs stored in a ROM (Read Only Memory) or a RAM (Random Access Memory) (not shown) to execute various operations such as “operation interface setting processing”, “first command processing” and “second command processing” described later.

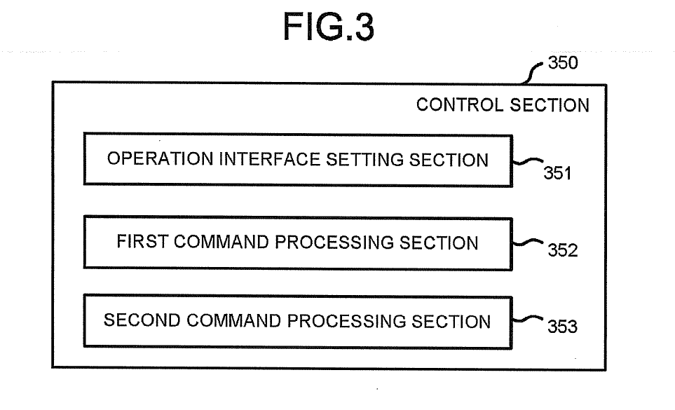

As shown in FIG. 3, the control section 350 operates according to the programs mentioned above to function as an operation interface setting section 351, a first command processing section 352 and a second command processing section 353. The first command processing section 352 and the second command processing section 353 can operate in parallel. The operations of the operation interface setting section 351, the first command processing section 352 and the second command processing section 353 are described below.

The control section 350 may be constituted by one or a plurality of processors. For example, each of the operation interface setting section 351, the first command processing section 352 and the second command processing section 353 may function as one processor. In a case in which the control section 350 is constituted by a plurality of processors, the control section 350 may realize the operation interface setting processing, the first command processing and the second command processing through the cooperation of the plurality of processors.

Next, the operations of the printer 300 with such a constitution are described. The processing executed by the printer 300 is divided into the operation interface setting processing, the first command processing and the second command processing. First, the operation interface setting processing is described.

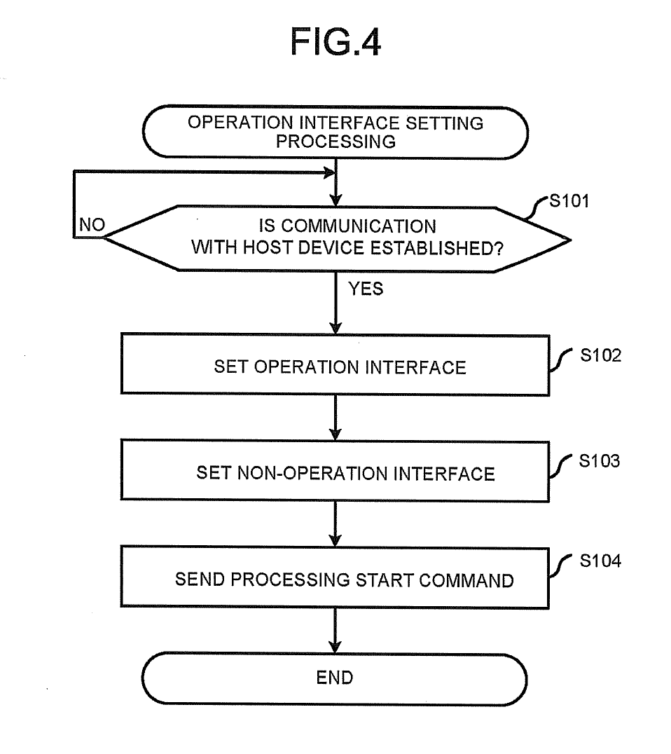

When the power source of the printer 300 is turned on, the control section 350 of the printer 300 starts the “operation interface setting processing”. The operation interface setting processing is executed by the operation interface setting section 351. Hereinafter, the operation interface setting processing is described with reference to the flowchart shown in FIG. 4.

The operation interface setting section 351 determines whether or not the host device 100 is connected with one of the plurality of communication interfaces 341 and the communication between the printer 300 and the host device 100 is established (ACT S101). In a case in which the communication with the host device 100 is not established (NO in ACT S101), the processing in ACT S101 is repeated until the communication is established.

In a case in which the communication with the host device 100 is established (YES in ACT S101), the operation interface setting section 351 sets the communication interface 341 connected with the host device 100 as the operation interface. That is, the operation interface setting section 351 sets the communication interface 341, which establishes communication with the host device 100 first after the printer 300 is started, as the operation interface (ACT S102). The operation interface refers to a communication interface capable of receiving a command (hereinafter referred to as a state change command) that can change the state of the printer 300. The state change command includes, for example, a printing execution command commanding the printer 300 to execute printing, and an internal setting value change command for rewriting the internal setting value of the printer 300.

Next, the operation interface setting section 351 sets the communication interfaces 341 other than the communication interface 341 connected with the host device 100 as non-operation interfaces (ACT S103). The non-operation interface refers to the communication interface which does not receive the state change command, so as to prevent the printer 300 from being turned into a state beyond the control of the host device 100. Specifically, the non-operation interface is the communication interface which can only receive a command (hereinafter referred to as an internal information request command) for requesting the internal information of the printer 300.

After the non-operation interfaces are set, the operation interface setting section 351 sends processing start commands to each of the first command processing section 352 and the second command processing section 353 (ACT S104). As stated above, the first command processing section 352 and the second command processing section 353 can operate in parallel. After the processing start commands are sent, the operation interface setting section 351 terminates the operation interface setting processing.

Next, the first command processing is described.

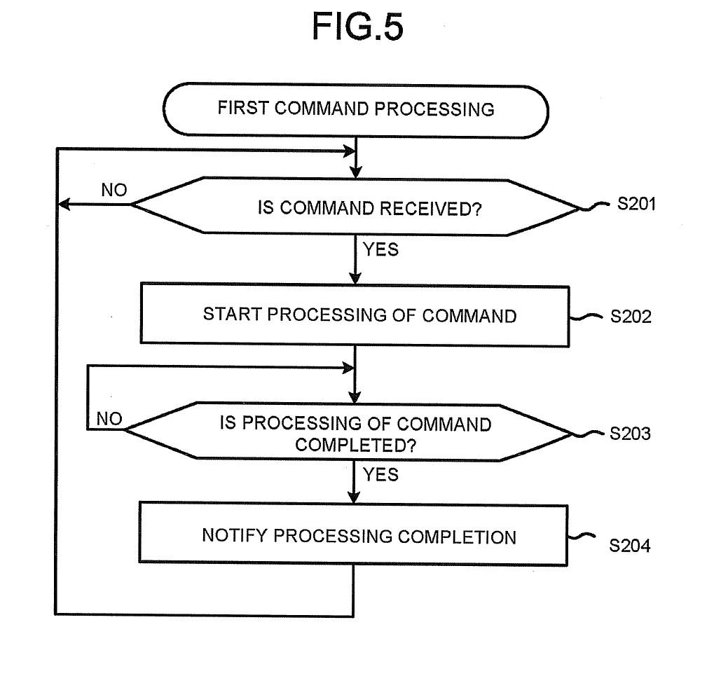

If receiving the processing start command from the operation interface setting section 351, the first command processing section 352 executes the “first command processing”. The first command processing is executed in parallel with the later-described second command processing. Hereinafter, the first command processing is described with reference to the flowchart shown in FIG. 5.

The first command processing section 352 determines whether or not the command is received from the host device 100 through the operation interface (ACT S201). If the command is not received from the host device 100 (NO in ACT S201), the first command processing section 352 executes the processing in ACT S201 repeatedly until the command is received.

If the command is received from the host device 100 (YES in ACT S201), the first command processing section 352 starts the processing indicated by the received command (ACT S202). For example, in a case in which the command received from the host device 100 is the printing execution command, the first command processing section 352 commands the printing section 330 to start the printing.

Next, the first command processing section 352 determines whether or not the processing of the command is completed (ACT S203). For example, in a case in which the command received from the host device 100 is the printing execution command, the first command processing section 352 determines whether or not the printing section 330 completes the requested printing processing. If the processing is not completed (NO in ACT S203), the first command processing section 352 executes the processing in ACT S203 repeatedly until the processing is completed.

If the processing is completed (YES in ACT S203), the first command processing section 352 notifies the host device 100 of the processing completion through the operation interface (ACT S204). After the notification is given, the first command processing section 352 executes the processing in ACT S201 again to wait for the reception of the next command.

Next, the second command processing is described.

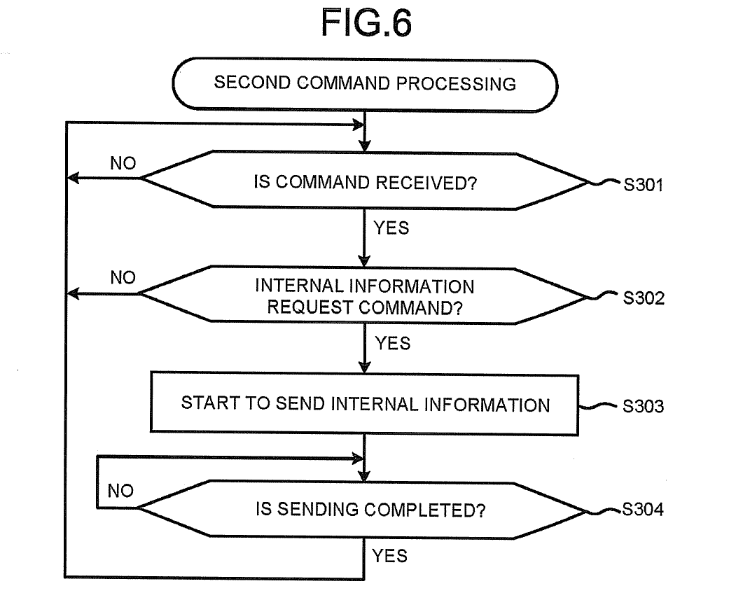

If receiving the processing start command from the operation interface setting section 351, the second command processing section 353 executes the “second command processing”. The second command processing is executed in parallel with the first command processing. Hereinafter, the second command processing is described with reference to the flowchart shown in FIG. 6.

The second command processing section 353 determines whether or not the command is received from the information acquisition device 200 through any of the non-operation interfaces (ACT S301). If the command is not received from the information acquisition device 200 (NO in ACT S301), the second command processing section 353 executes the processing in ACT S301 repeatedly until the command is received.

If the command is received from the information acquisition device 200 (YES in ACT S301), the second command processing section 353 determines whether or not the received command is the internal information request command (ACT S302). In a case in which the received command is not the internal information request command (NO in ACT S302), the second command processing section 353 returns to execute the processing in ACT S301 without processing the received command.

In a case in which the received command is the internal information request command (YES in ACT S302), the second command processing section 353 starts to send the internal information designated in the command (ACT S303). For example, in a case in which the internal information designated in the command is the internal setting value of the printer 300, the second command processing section 353 reads the internal setting value from the storage section 320. Then the second command processing section 353 sends the internal setting value to the information acquisition device 200 through the non-operation interface connected with the information acquisition device 200. Further, in a case in which the internal information designated in the command is the error information, the second command processing section 353 reads the error information from the storage section 320. Then the second command processing section 353 sends the error information to the information acquisition device 200 through the non-operation interface connected with the information acquisition device 200.

Next, the second command processing section 353 determines whether or not the sending of the internal information is completed (ACT S304). If the sending processing is not completed (NO in ACT S304), the second command processing section 353 executes the processing in ACT S304 repeatedly until the sending processing is completed. If the sending processing is completed (YES in ACT S304), the second command processing section 353 executes the processing in ACT S301 again to wait for the reception of the next command.

It is exemplified in the present embodiment that the printer 300 executes the processing of the command in a case in which the command received by the non-operation interface is the internal information request command, and does not execute the processing of the command in other cases. Thus, the user can acquire the internal information of the printer 300 even if the printer 300 is operating.

Furthermore, the command that the non-operation interface can receive only includes the internal information request command which does not change the state of the printer 300. Thus, the printer 300 is not turned into a state beyond the control of the host device 100 when the user acquires the internal information of the printer 300.

The embodiment stated above is presented by way of example only, and various changes and applications can be implemented.

For example, in the embodiment described above, the operation interface setting section 351 sets the communication interface 341, which establishes communication with the host device 100 first after the printer 300 is started, as the operation interface. However, the operation interface setting section 351 may set the communication interface 341 designated by the user within the plurality of communication interfaces 341 as the operation interface. For example, the printer 300 stores the setting designated by the user in the storage section 320. Then the operation interface setting section 351 sets the communication interface 341, which is set as the operation interface by the user, as the operation interface based on the setting stored in the storage section 320.

The number of the communication interface 341 set as the operation interface by the operation interface setting section 351 is not limited to one. The operation interface setting section 351 may set a plurality of communication interfaces 341 as the operation interfaces as long as the communication section 340 is provided with more than two communication interfaces 341. For example, the operation interface setting section 351 may set the communication interface 341 which establishes communication with the host device 100 first and the communication interface 341 which establishes communication with the host device 100 secondly after the printer 300 is started as the operation interfaces. Further, the operation interface setting section 351 may set a plurality of communication interfaces 341, which are set as the operation interfaces by the user, as the operation interfaces.

It is exemplified in the embodiment described above that the second command processing section 353, if receiving the internal information request command from the information acquisition device 200, executes the sending of the internal information regardless of the command execution state of the first command processing section 352. However, in a case in which the first command processing section 352 already started the processing of the command, the second command processing section 353 may temporarily interrupt the processing of the internal information sending command (that is, the sending of the internal information), and restart the processing of the internal information request command after the first command processing section 352 completes the processing of the command. The first command processing section 352 and the second command processing section 353 cannot carry out processing at the same time, thus, the delay of the processing carried out by the first command processing section 352 can be reduced. Particularly, in a case in which the first command processing section 352 needs to read a great deal of information from the storage section 320, the reading of the internal information from the storage section 320 by the second command processing section 353 is interrupted, thus, the first command processing section. 352 can read information from the storage section 320 quickly.

It is exemplified in the embodiment described above that the printer 300 consists of four communication interfaces 341, that is, the LAN interface, the USB interface, the RS-232C serial interface and the centronics parallel interface. However, not limited to four, the number of communication interfaces 341 included in the communication section 340 may be more or less than four. For example, the printer 300 may consist of two types of communication interfaces selected from the four types of communication interfaces mentioned above.

Further, the printer 300 may consist of a communication interface other than the four types of communication standards mentioned above. For example, the printer 300 may consist of an IEEE1394 interface, an ATA (AT Attachment) interface or a SATA (Serial ATA) interface. In addition, the ATA (AT Attachment) interface includes an IDE interface and an ATAPI interface. The SATA (Serial ATA) interface includes an ESATA (External SATA).

The printer 300 is equipped with a wireless communication interface as the communication interface 341. The wireless communication interface may be a wireless LAN interface, a Bluetooth interface or an infrared communication interface. The printer 300 may include a plurality of wireless communication interfaces so that the information acquisition device 200 can use the other wireless communication interfaces as non-operation interfaces even if the host device 100 uses one of the wireless communication interfaces as the operation interface. The plurality of wireless communication interfaces may be a wireless communication interface of the same type, or wireless communication interfaces of different types.

It is exemplified in the embodiment described above that the printing section 330 is a dot impact type or a thermal type printing unit; however, the printing method used by the printing section 330 is not limited to the dot impact method or the thermal printing method. For example, the printing method used by the printing section 330 may be an electrophotographic type used by a laser printer or a LED (Light Emitting Diode) printer, or an inkjet type used by an inkjet printer.

It is exemplified in the embodiment described above that the printer 300 is a barcode printer used in a manufacturing line; however, the printer 300 is not limited to this. For example, the printer 300 may be a barcode printer used in a distribution center for printing one-dimensional code or two-dimensional code on a sheet to be attached to package.

The content printed by the printer 300 may include other information than the one-dimensional code and the two-dimensional code. For example, the content printed by the printer 300 may include information such as product name, manufacturing date, raw material name and the like.

In the embodiment described above, the one-dimensional code that the printer 300 can print is described as the UPC or the CODE39; however, it is not limited to this. For example, the one-dimensional code that the printer 300 can print may be EAN (European Article Number), JAN (Japanese Article Number), NW-7, ITF (Interleaved Two of Five) and MSI.

In the embodiment described above, the two-dimensional code (two-dimensional barcode) that the printer 300 can print is described as the DATA Matrix or the QR-code; however, it is not limited to this. For example, the two-dimensional code that the printer 300 can print may be PDF417, Maxi Code and Veri Code.

Further, the printer 300 is not limited to the barcode printer. For example, the printer 300 may be a label printer which carries out printing on a label, a photo printer which carries out printing on photo paper, or a normal printer which carries out printing on normal paper.

The control device for controlling the printer 300 of the present embodiment may be realized by a dedicated computer system, or a normal computer system. For example, the control device may be constituted by storing the program for executing the operations described above in a computer-readable recording medium such as an optical disk, a semiconductor memory, a magnetic tape, flexible disk and the like, and installing the program into the computer to execute the processing. It is also applicable to store the program in a disk device of a server device on network such as internet in advance and then download the program to the computer. Further, the function mentioned above can also be realized through the cooperation with an OS (Operating System) and application software. In this case, the part other than the OS may be stored in a medium; alternatively, the part other than the OS may be stored in the server device in advance and then downloaded to the computer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A printer comprising:
a plurality of communication interfaces;
an operation interface setting section configured to assign one of the plurality of communication interfaces an operation interface and assign the other communication interfaces non-operation interfaces;
a first command processing section configured to process a command received by the operation interface; and
a second command processing section configured to process a command received by the non-operation interface.

2. The printer according to claim 1, wherein
the command received by the non-operation interface includes a request for at least one of an internal setting value and error information.

3. The printer according to claim 1, wherein
the operation interface setting section sets the communication interface, which establishes communication first after the printer is started, as the operation interface.

4. The printer according to claim 1, further comprising:
a storage section configured to store a setting designated by a user; wherein
the operation interface setting section assigns the one or a plurality of communication interfaces, which are set as the operation interfaces by the user, as the operation interfaces based on the setting stored in the storage section.

5. The printer according to claim 1, wherein
the second command processing section during the processing of the command received by the non-operation interface temporarily interrupts the processing of the command received by the non-operation interface in a case in which the first command processing section already started the processing of the command received by the non-operation interface, and restarts the processing of the command received by the non-operation interface after the first command processing section completes the processing of the command received by the non-operation interface.

6. The printer according to claim 1, wherein
the plurality of communication interfaces includes a plurality of wireless communication interfaces; wherein
the operation interface setting section assigns at least one of the plurality of communication interfaces as the operation interface, and assigns the other communication interfaces including at least one wireless communication interface as the non-operation interfaces.

7. The printer according to claim 1, wherein
the plurality of communication interfaces is of different communication standards.

8. The printer according to claim 1, wherein
the plurality of communication interfaces includes two or more than two types of communication interfaces selected from LAN interface, USB interface, RS-232C interface, centronics parallel interface, IEEE1394 interface, ATA interface and SATA interface.

9. A barcode printer comprising:
a plurality of communication interfaces;
an operation interface setting section configured to assign one of the plurality of communication interfaces an operation interface and assign the other communication interfaces non-operation interfaces;
a first command processing section configured to process a command received by the operation interface;
a second command processing section configured to process the processing of a command received by the non-operation interface; and
a printing section configured to print one-dimensional code or two-dimensional code.

10. The barcode printer according to claim 9, wherein
the command received by the non-operation interface includes a request for at least one of an internal setting value and error information.

11. The barcode printer according to claim 9, wherein
the operation interface setting section sets the communication interface, which establishes communication first after the printer is started, as the operation interface.

12. The barcode printer according to claim 9, further comprising:
a storage section configured to store a setting designated by a user; wherein
the operation interface setting section assigns the one or a plurality of communication interfaces, which are set as the operation interfaces by the user, as the operation interfaces based on the setting stored in the storage section.

13. The barcode printer according to claim 9, wherein
the second command processing section during the processing of the command received by the non-operation interface temporarily interrupts the processing of the command received by the non-operation interface in a case in which the first command processing section already started the processing of the command received by the non-operation interface, and restarts the processing of the command received by the non-operation interface after the first command processing section completes the processing of the command received by the non-operation interface.

14. The barcode printer according to claim 9, wherein
the plurality of communication interfaces includes a plurality of wireless communication interfaces; wherein
the operation interface setting section assigns at least one of the plurality of communication interfaces as the operation interface, and assigns the other communication interfaces including at least one wireless communication interface as the non-operation interfaces.

15. A printer control method including:
an operation interface setting step of assigning one of a plurality of communication interfaces of a printer an operation interface, and assigning the other communication interfaces non-operation interfaces;
a first command processing step of processing of a command received by the operation interface;
a second command processing step of processing of a command received by the non-operation interface.

16. The printer control method according to claim 15, wherein
the command received by the non-operation interface includes a request for at least one of an internal setting value and error information.

17. The printer control method according to claim 15, wherein
the operation interface setting step comprises setting the communication interface, which establishes communication first after the printer is started, as the operation interface.

18. The printer control method according to claim 15, wherein
the operation interface setting step comprises assigning the one or a plurality of communication interfaces, which are set as the operation interfaces by the user, as the operation interfaces based on a setting stored in a storage section.

19. The printer control method according to claim 15, wherein
the second command processing step comprises temporarily interrupting the processing of the command received by the non-operation interface during the processing of the command received by the non-operation interface, in a case in which the first command processing step already started the processing of the command received by the non-operation interface, and restarting the processing of the command received by the non-operation interface after the first command processing step completes the processing of the command received by the non-operation interface.

20. The printer control method according to claim 15, wherein
the plurality of communication interfaces includes a plurality of wireless communication interfaces; wherein
the operation interface setting step comprises assigning at least one of the plurality of communication interfaces as the operation interface, and assigning the other communication interfaces including at least one wireless communication interface as the non-operation interfaces.
